(19) United States
(12) Patent Application Publication
(10) Pub. No.: US 2026/0279048 A1
(43) Pub. Date: Sep. 17, 2026

(54) DATA CURATION FOR MODELLING OBJECT STATE TRANSITIONS

(71) Applicant: XILINX, INC., SAN JOSE, CA (US)

(72) Inventors: Takashi Isobe, Beijing (CN); MengMeng Ge, Beijing (CN); Dong Li, Beijing (CN); Dong Zhou, Beijing (CN); Emad Barsoum, Sammamish, WA (US)

(21) Appl. No.: 19/273,569

(22) Filed: Jul. 18, 2025

Related U.S. Application Data
(60) Provisional application No. 63/771,398, filed on Mar. 13, 2025.

(51) Int. Cl. G06V 20/40; G06T 7/20; G06V 10/74; G06V 10/774; G06V 10/98

(52) U.S. Cl. CPC G06V 20/41; G06T 7/20; G06V 10/761; G06V 10/774; G06V 10/993; G06V 20/49; G06T 2207/10016; G06T 2207/20081; G06T 2207/30168

(57) ABSTRACT

A video is partitioned into video segments corresponding to object state transitions depicted in the video and a subset of the video segments is selected based on visual quality scores for the video segments. Action instructions for the subset of the video segments are generated based on the object state transitions depicted in the video segments in the subset and a text caption of the video. The subset of the video segments and the corresponding captions are stored in memory. In some cases, an image-to-video (I2V) generation model is trained to perform instructed visual state transition (IVST) based on the stored information representing the subset of the video segments and the corresponding captions. The subset can be selected based on a measure of similarity between initial and final frames, average optical flows within the video segments, light levels, brightnesses, blurriness, or noise levels.

### BACKGROUND

Machine learning (ML) models, which include artificial intelligence (AI) models and techniques, operate on numerical representations of data such as text, audio, images, and video. A typical numerical representation is an embedding, such as a vector embedding, that encodes features of the data in a series (or vector) of numerical values. An ML model is trained to transform the numerical representation of the input data (e.g., the embedding vector) into one or more output values such as a value indicating the identity of a feature in the data, a classification of the feature, or a value that is predicted based upon the input data. One class of ML models, generative AI models, generate new data (such as text, images, or videos) based on underlying patterns and structures that are “learned” from the training data. Relatively small generative AI models are represented by a few billion parameters and can run on a smart phone, larger models having tens of billions of parameters can run on laptop or desktop computers, and the largest models (such as typical large language models, LLMs) include hundreds of billions of parameters and typically run on arrays of parallel processors such as graphics processing units (GPUs) implemented in a server.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that performs curation of data that is used to train models that generate images representing object state transitions, according to some embodiments.

FIG. 2 illustrates frames of a video that can be partitioned for data curation, according to some embodiments.

FIG. 3 illustrates a process or method of selecting a subset of video segments based on visual quality scores, according to some embodiments.

FIG. 4 illustrates a video that can be partitioned to create video segments that are used to train an image-to-view (I2V) generation model, according to some embodiments.

FIG. 5 illustrates video segments that represent partitions of a video, according to some embodiments.

FIG. 6 illustrates a process or method of generating modified action instructions for video segments that have higher semantic consistency with a text caption of a video, according to some embodiments.

FIG. 7 illustrates a method of training an I2V generation model to perform instructed visual state transition (IVST) and performing IVST using the trained I2V generation model, according to some embodiments.

### DETAILED DESCRIPTION

Image-to-video (I2V) generation models aim to synthesize videos conditioned on input images and text prompts. In the instructed visual state transition (IVST) task, the objective is to generate a plausible transition of an object’s state between images in an initial frame and an end frame, guided by a textual description. The initial frame depicts the object in its starting state, while the end frame represents the target state. However, existing I2V models often struggle to generate coherent intermediate frames that reflect a realistic state transition, primarily due to limited reasoning capabilities. This challenge is largely attributed to the lack of high-quality, instruction-aligned training data. For example, existing text-video datasets are focused on understanding actions or activities. These training sets do not typically include video segments that represent object state transitions with text captions that describe the object state transition. Furthermore, many text-video data sets include low-quality video that is blurry, noisy, has low light levels, or otherwise exhibit low video quality. Excessive camera movement can also cause key objects to shift out of focus or frame, which disrupts visual continuity. The video segments in text-video datasets typically have long durations and depict numerous object state transitions that are not described or characterized by the associated captions. Thus, training an I2V generation model on typical text-video datasets will not enable the I2V generation model to learn the relationship between a text description of an object state transition and the video representation of the object state transition.

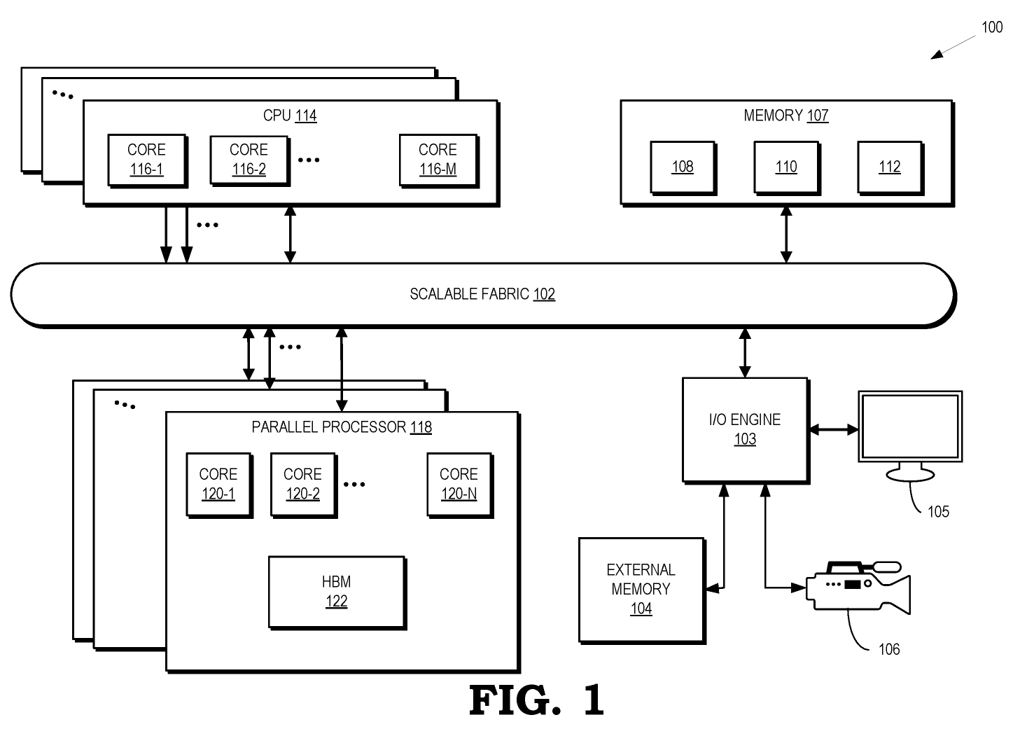

FIGS. 1-6 illustrate methods, apparatuses, and systems for generating datasets suitable for training machine learning (ML) models such as image-to-video (I2V) generation models by partitioning a video into video segments corresponding to object state transitions depicted in the video. A subset of the video segments is selected based on visual quality scores for the video segments. Selecting the subsets of the video segments includes determining a measure of similarity between initial and final frames of each video segment and determining an average optical flow within each video segment. As used herein, the term “optical flow” refers to the distribution of apparent velocities of movement of a brightness pattern in an image or set of images. The optical flow represents a pattern of apparent motions of objects, surfaces, edges, or other features in a visual scene caused by relative motion between an observer and the scene. Video segments with low measures of similarity and/or low average optical flows are discarded because these video segments do not include a clear object state transition, or they include significant scene or viewpoint changes. For example, a video segment with an average optical flow below a threshold can be discarded. Visual quality scores for the video segments can be generated based on visual characteristics such as light levels or brightness of the video segment, blurriness of the video segment, noise within the video segment, and the like. For example, a low visual quality score is given to video segments that have low light levels, low brightness, high levels of blurriness, and/or high levels of noise. In some embodiments, a visual quality score is determined by comparing a visual characteristic of the video segment to a corresponding threshold.

Text captions, which are also referred to herein as action instructions, are generated for the selected subset of the video segments. In some embodiments, the text captions of the video segments are evaluated for semantic consistency with a text caption of the video, which can be provided as part of the video data. High semantic consistency between the text caption of the video segment and the text caption of the video indicates that the text caption for the video segment is describing the overall scene and not the object state transition depicted in the video segment. Video segments with high semantic consistency can therefore be discarded. In some embodiments, a multimodal large language model (MLLM) generates text captions that reflect the content of the video segments more accurately than a caption associated with the video. The MLLM can also generate captions for an initial frame of the video and an end frame of the video, as well as a text description of a state transition between the initial frame and the end frame. In some embodiments, the MLLM re-captions video segments with high semantic consistency to generate a modified text caption that has low semantic consistency with the text caption of the video. Video segments that are re-captioned with a low semantic consistency caption may not need to be discarded. The subset of the video segments, the corresponding captions, and (if generated by the MLLM) text descriptions are stored in a memory for subsequent training of an ML model such as an I2V generation model to perform tasks such as instructed visual state transition (IVST). In some embodiments, the Image-to-Video (I2V) generation model is trained on curated video segments that contain four pieces of information: (1) the video frames within each segment, (2) captions for the initial and end frames, (3) an action instruction describing the video segment, and (4) a textual description of the state transition between the initial and end frames. During training, the three textual components - (2), (3), and (4) - can be concatenated into a single, comprehensive prompt corresponding to each video segment.

FIG. 1 is a block diagram of a processing system 100 that performs curation of data that is used to train models that generate images representing object state transitions, according to some embodiments. The processing system 100 includes a scalable fabric 102 implemented with circuitry that supports communication between entities implemented in the processing system 100. The scalable fabric 102 can include a control fabric for conveying control signals and a data fabric for conveying data between entities in the processing system 100. Some implementations of the processing system 100 include other buses, bridges, switches, routers, and the like, which are not shown in FIG. 1 in the interest of clarity. An input/output (I/O) engine 103 is implemented with circuitry that handles input or output operations associated with an external memory 104, a display 105, a video capture or generation device such as a camera 106, as well as other elements of the processing system 100 such as keyboards, mice, printers, speakers, headphones, and the like. The I/O engine 103 is coupled to the scalable fabric 102 so that the I/O engine 103 can communicate with other entities in the processing system 100 by exchanging signals over the scalable fabric 102.

Processing system 100 includes or has access to a memory 107 or other storage component(s) implemented using a non-transitory computer-readable medium such as a dynamic random-access memory (DRAM). However, some embodiments of the memory 107 are implemented using other types of memory including, for example, static random-access memory (SRAM), nonvolatile RAM, and the like. Some embodiments of memory 107 include an external memory implemented external to the processing units implemented in the processing system 100. The memory 107 can store information representing instructions such as program code 108 for one or more applications (e.g., graphics applications, compute applications, ML models or applications), data 110 that is consumed by the program code 108, and results 112 produced by executing the program code 108.

One or more central processing units (CPUs) 114 are deployed in the processing system 100, although only one CPU 114 is indicated by a reference numeral in the interest of clarity. The CPU 114 is connected to the scalable fabric 102 to communicate with other entities in the processing system 100, such as the I/O engine 103, the memory 107, or other entities connected to the scalable fabric 102. The CPU 114 includes circuitry configured to implement a plurality of processor cores 116-1, 116-2, … 116-M that execute instructions concurrently or in parallel. Although three processor cores 116 are shown in FIG. 1, more or fewer processor cores 116 can be implemented in other embodiments of the CPU 114. The processor cores 116 include circuitry to implement one or more compute units such as single-instruction, multiple data (SIMD) units that perform the same operation on different data sets to produce one or more results. The CPU 114 is configured to execute instructions such as the program code 108 for one or more applications (e.g., graphics applications, compute applications, machine learning applications), which is stored in the memory 107. The CPU 114 can consume data 110 and store information in memory 107 such as the results 112 of the executed instructions.

The processing system 100 also includes one or more parallel processors 118, although only one parallel processor 118 is indicated by a reference numeral in the interest of clarity. The parallel processors 118 can include, for example, a GPU, a general-purpose GPU (GPGPU), a neural processing unit (NPU), a tensor processing unit (TPU), an intelligence processing unit (IPU), or other vector processor or type of parallel processor. The parallel processors 118 include circuitry to implement one or more processor cores 120-1…N that each operate as a compute unit configured to perform one or more operations based on one or more instructions received by the parallel processors 118. The instructions or operations can be performed or executed concurrently by the processor cores 120. Although three processor cores 120 are shown in FIG. 1, more or fewer processor cores 120 can be implemented in other embodiments of the parallel processor 118. The compute units in the processor cores 120 are implemented as circuitry for one or more single-instruction, multiple data (SIMD) units that perform the same operation on different data sets to produce one or more results.

In the illustrated embodiment, the parallel processors 118 include circuitry for storing data such as one or more high bandwidth memories (HBM) 122 that are used to store instructions or data that are accessed by one or more of the processor cores 120 via high bandwidth connections (not shown in FIG. 1 in the interest of clarity). Some embodiments of the HBM 122 store instructions or information that has been retrieved or fetched from memory 107. For example, instructions can be fetched from the program code 108 and stored in HBM 122; data can be fetched from data 110 and stored in the HBM 122. Although the HBM 122 is shown internal to parallel processor 118 and external to the processor cores 120, some embodiments of the processor cores 120 include additional, internal HBM or caches and some embodiments of the HBM 122 are implemented external to the parallel processor 118.

As discussed herein, generative AI models such as image-to-video (I2V) generation models aim to synthesize videos conditioned on input images and text prompts. In the instructed visual state transition (IVST) task, the objective is to generate a plausible transition of an object’s state between images in an initial frame and an end frame, guided by a textual description. However, existing I2V models often struggle to generate coherent intermediate frames that reflect a realistic state transition, at least in part due to the lack of high-quality, instruction-aligned training data for the I2V models. The processing system 100 is therefore configured to create training data for object state transitions from existing video data. As used herein, the phrase “object state transition” refers to a change in the visual appearance or location of an object depicted in multiple frames of a video or video segment. For example, an object state transition can refer to a change in the color or illumination of an object from a first frame in a video to a second frame. For another example, an object state transition can refer to a change in a location of an object from the first frame in the video to the second frame.

In the illustrated embodiment, one or more processing units in the processing system 100 generate training data by partitioning a video into video segments corresponding to object state transitions depicted in the video. The processing units can include compute units in the cores 116, the cores 120, or a combination thereof. The processing unit(s) select a subset of the video segments based on visual quality scores for the video segments. For example, the subset can be selected based on one or more of a light level of the video segment, a brightness of the video segment, a blurriness of the video segment, or a noise level within the video segment. The processing units generate action instructions for the subset of the video segments based on the object state transitions depicted in the video segments in the subset and a text caption of the video. As used herein, the term “action instruction” refers to a text description of the object state transition that is depicted in the video segment. For example, if the object state transition corresponds to a car moving from the left side of a first frame to the right side of a second frame, the action instruction could be “the car moves from the left side of the image to the right side of the image.” The action instruction can also be considered a text caption of the video segment. The processing unit(s) store the subset of the video segments and the corresponding captions or action instructions in memory such as the memory 107.

Some embodiments of the processing system 100 can also be configured to train ML models, such as an I2V generation model, based on training data stored in the memory 107. In some embodiments, the parallel processor 118 accesses a subset of video segments from the memory 107. As discussed herein, the subset is selected based on visual quality scores for the video segments and the video segments represent partitions of a video corresponding to object state transitions depicted in the video. The parallel processor 118 also accesses action instructions associated with the subset of the video segments from the memory 107, as well as accessing a text caption of the video. As discussed herein, the instructions indicate the object state transitions depicted in the video segments in the subset. The parallel processor 118 then trains the I2V generation model based on the action instructions associated with the subset and the text caption. For example, the parallel processor 118 can train the I2V generation model to perform instructed visual state transition (IVST). Additional information can also be used to train the I2V generation model. For example, the I2V generation model can be trained based on one or more of the subset of the video segments, the corresponding action instructions, a text caption of an initial frame of the video, a text caption of an end frame of the video, and a text description of a state transition between the initial frame and the end frame. Although in the illustrated embodiment training is performed by the same processing system 100 that curated the data used to train the model, different processing systems can be used to generate the curated data and train the model in other embodiments.

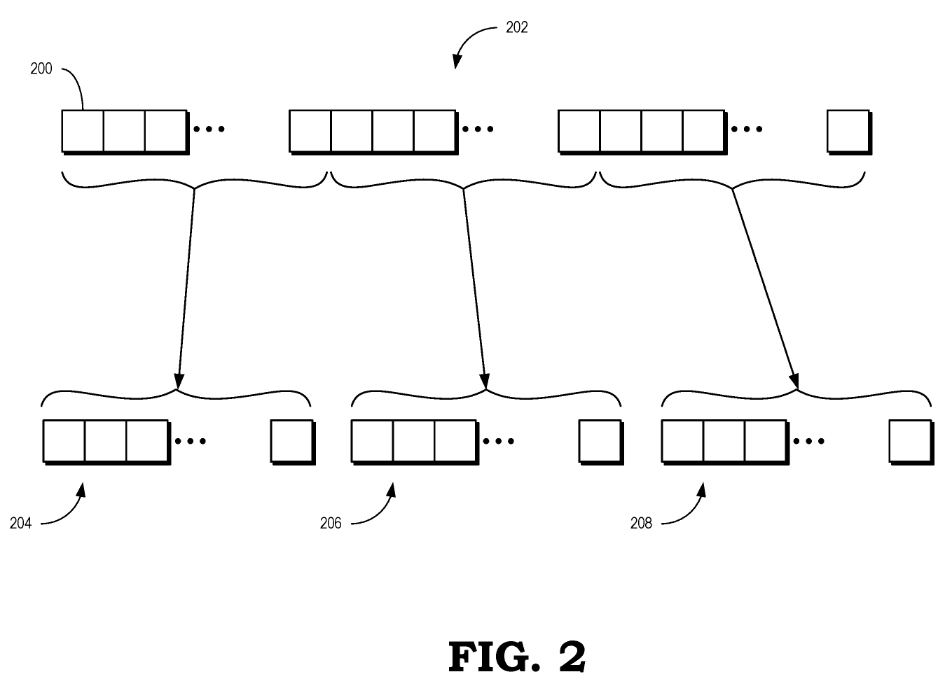

FIG. 2 illustrates frames 200 of a video 202 that can be partitioned for data curation, according to some embodiments. Only one frame 200 is indicated by a reference numeral in the interest of clarity. The video 202 is partitioned into a set of video segments 204, 206, 208 by a processing unit such as a CPU 114, the parallel processor 118, or one or more compute units in the CPU 114 or the parallel processor 118 shown in FIG. 1. Partitioning is performed based on object state transitions depicted in the video segments 204, 206, 208. In the illustrated embodiment, the video segment 204 depicts a first object state transition, the video segment 206 depicts a second object state transition, and the video segment 208 depicts a third object state transition. The number of frames in the video segments 204, 206, 208 typically depends on the duration of the object state transition, which varies based upon characteristics of the transition depicted in the video segments 204, 206, 208.

The suitability of the video segments 204, 206, 208 for training a model, such as an I2V generation model, to perform tasks such as IVST varies between the video segments 204, 206, 208. The variation in the suitability can be caused by variations in the quality of the video segments 204, 206, 208. For example, low-quality video segments are characterized by issues such as blurriness, low brightness, or noise that obscure the visual cues that are relevant for training a model to understand and learn the corresponding object state transitions. Variations in the suitability of the video segments 204, 206, 208 can also be caused by camera motion during the video segments 204, 206, 208. For example, excessive camera movement can cause the key object that is making the transition to shift out of focus or out of the frame, which disrupts the visual continuity that enables state transitions to be effectively modeled by the I2V generation model. A subset of the video segments 204, 206, 208 is therefore selected based on their suitability for training the model. In some embodiments, suitability is indicated by one or more visual quality scores associated with the video segments 204, 206, 208.

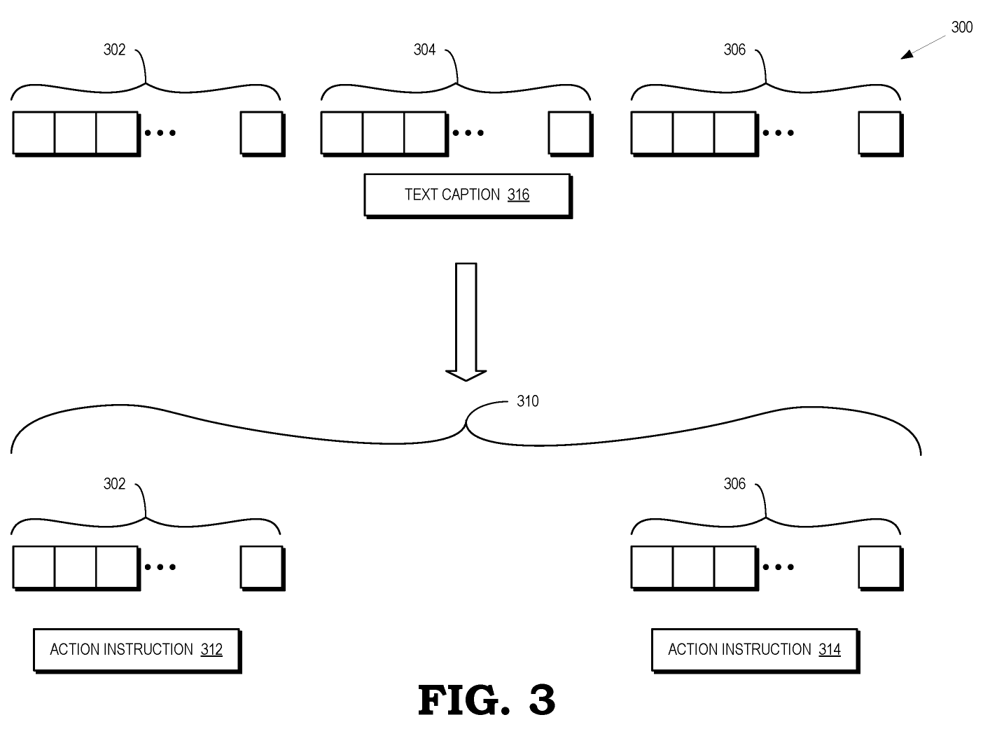

FIG. 3 illustrates a process or method 300 of selecting a subset of video segments 302, 304, 306 based on visual quality scores, according to some embodiments. The video segments 302, 304, 306 can correspond to some embodiments of the video segments 204, 206, 208 shown in FIG. 2. In some embodiments, data curation includes selecting a subset 310 including one or more of the video segments 302, 304, 306 based on a measure of similarity between initial and final frames of the video segments 302, 304, 306, average optical flows within the video segments 302, 304, 306, or a combination thereof. For example, selecting the subset 310 can include discarding video segments (such as the video segment 304) having one or more of a low measure of similarity or a low average optical flow so that the subset 310 includes the video segments 302 and 306.

In some embodiments, data curation includes generating a visual quality score for one or more of the video segments 302, 304, 306 based on visual characteristics of the video segments 302, 304, 306. The visual characteristics can include light levels of the video segments 302, 304, 306, brightnesses of the video segments 302, 304, 306, blurriness of the video segments 302, 304, 306, noise levels within the video segments 302, 304, 306, and the like. For example, a low visual quality score can be assigned to one of the video segments 302, 304, 306 that has one or more of a low light level, a low brightness, a high level of blurriness, or a high level of noise. Visual quality scores associated with different visual characteristics can be added or otherwise combined to generate a single visual quality score for each of the video segments 302, 304, 306. For example, a video segment that has a low light level and a low brightness may have a lower visual quality score than a video segment that has a low light level and a high brightness. In some embodiments, the visual quality scores are generated by comparing visual characteristics of the video segments 302, 304, 306 to corresponding thresholds, such as a threshold light level, a threshold brightness, a threshold blurriness, or a threshold noise level.

The subset 310 is selected based, at least in part, on the visual quality scores for the video segments 302, 304, 306. In the illustrated embodiment, the video segments 302, 306 are selected for the subset 310 and the video segment 304 is discarded. The video segment 304 can be discarded based on a measure of similarity, the average optical flow, the visual quality score associated with the segment 304, or a combination thereof. Once the video segments 302, 306 are selected for the subset 310, or in response to selecting the subset 310, action instructions 312, 314 are generated for the video segments 302, 306. The action instructions 312, 314 are generated based on the object state transitions depicted in the video segments 302, 306 and a text caption 316 of the video. In some embodiments, the action instructions 312, 314 are evaluated for semantic consistency with the text caption 316. A high semantic consistency between the text caption 316 and the action instruction 312 or action instruction 314 indicates that the corresponding action instruction 312 or 314 conveys similar or substantially the same information as the text caption. Thus, video segments associated with action instructions that have high semantic consistency with the text caption 316 can be discarded or, in some embodiments, the action instructions that have high semantic consistency can be modified to reduce their semantic consistency with the text caption 316 and more accurately reflect or describe the object state transition depicted in the corresponding video segment.

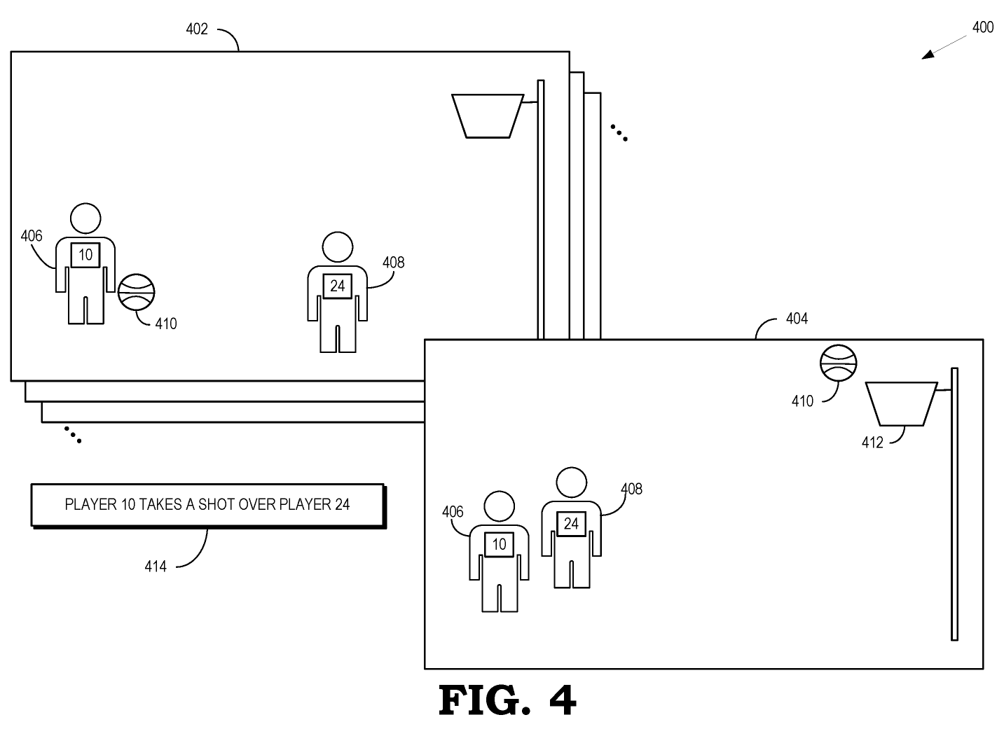

FIG. 4 illustrates a video 400 that can be partitioned to create video segments that are used to train an I2V generation model, according to some embodiments. The video 400 is composed of numerous frames including an initial frame 402 and an end frame 404. In the illustrated embodiment, the video 400 depicts two basketball players 406, 408 that are referred to herein as “player 10” and “player 24” based on the numbers on their jerseys. The basketball player 406 has possession of a basketball 410 in the initial frame 402 and the basketball player 408 is relatively distant from the basketball player 406. In the end frame 404, the basketball player 408 has moved to a position near and in front of the basketball player 406, and the basketball 410 is near the basket 412. A text caption 414 includes information indicating what has occurred during the video 400, which in this case is that “Player 10 takes a shot over player 24.”

The video 400 includes segments that represent multiple object state transitions. Examples of the object state transitions that can be found in the video include the basketball player 408 moving from the right side of the frame to the left side of the frame and the basketball 410 traveling from a location near the basketball player 406 to a different location near the hoop 416. The text caption 414 does not describe or characterize the object state transitions in the video. Thus, training an I2V generation model on a text-video dataset that includes the video 400 will not necessarily enable the I2V generation model to learn the relationship between a text description of an object state transition and the video representation of the object state transition.

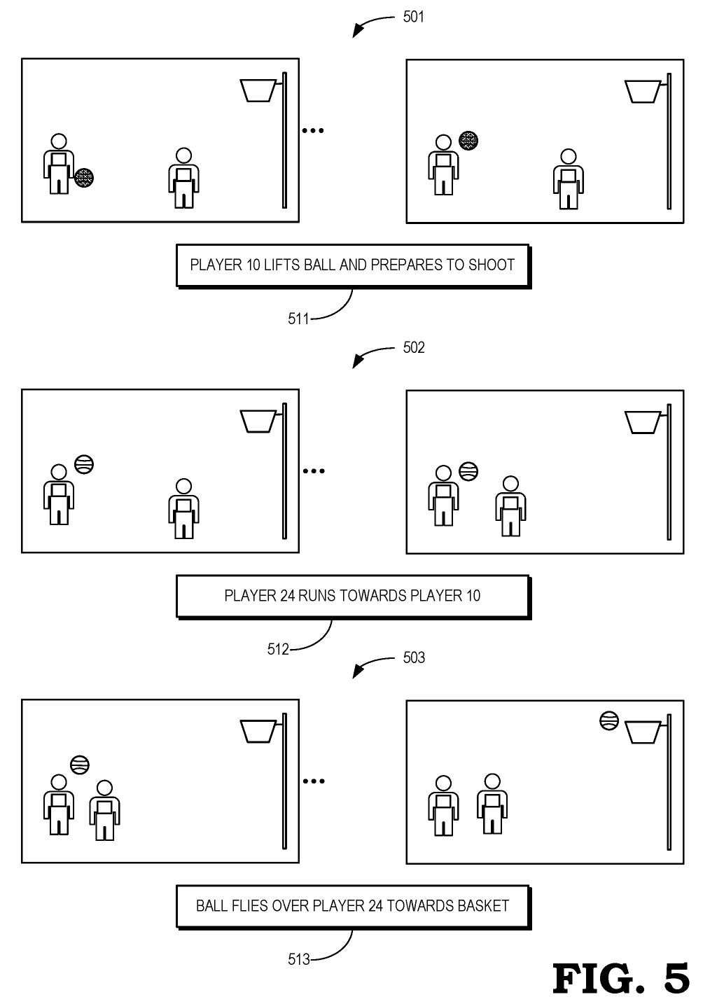

FIG. 5 illustrates video segments 501, 502, 503 that represent partitions of a video, according to some embodiments. The video segments 501, 502, 503 can be formed by partitioning the video 400 shown in FIG. 4. In some embodiments, the video segments 501, 502, 503 are defined or selected based on measures of similarity between initial and final frames of the video segments 501, 502, 503, average optical flows within the video segments 501, 502, 503, or a combination thereof. Action instructions 511, 512, 513 are generated for the video segments 501, 502, 503 based on the object state transitions depicted in the video segments 501, 502, 503 and a text caption of the video such as the text caption 414 shown in FIG. 4. In the illustrated embodiment, the action instruction 511 includes text indicating that the corresponding video segment 501 depicts an object state transition in which “player 10 lifts ball and prepares to shoot.” The action instruction 512 includes text indicating that the corresponding video segment 502 depicts an object state transition in which “player 24 runs towards player 10.” The action instruction 513 includes text indicating that the corresponding video segment 503 depicts an object state transition in which “ball flies over player 24 towards basket.”

As discussed herein, the action instructions 511, 512, 513 can be tested, checked, or evaluated for semantic consistency with the text caption 414. Video segments 501, 502, 503 that are associated with action instructions 511, 512, 513 that have high semantic consistency with the text caption 414 can be discarded from the subset that is stored for training ML models such as I2V generation models. Video segments 501, 502, 503 that are associated with action instructions 511, 512, 513 that have low semantic consistency with the text caption 414 are retained in the subset that is stored for subsequent model training. In some embodiments, one or more of the action instructions 511, 512, 513 that have high semantic consistency with the text caption 414 can be modified to create modified action instructions that have low semantic consistency with the text caption 414 and can therefore be retained in the subset that is stored for subsequent model training because the modified action instruction provides a better or more accurate description of the object state transition depicted in the corresponding video segment.

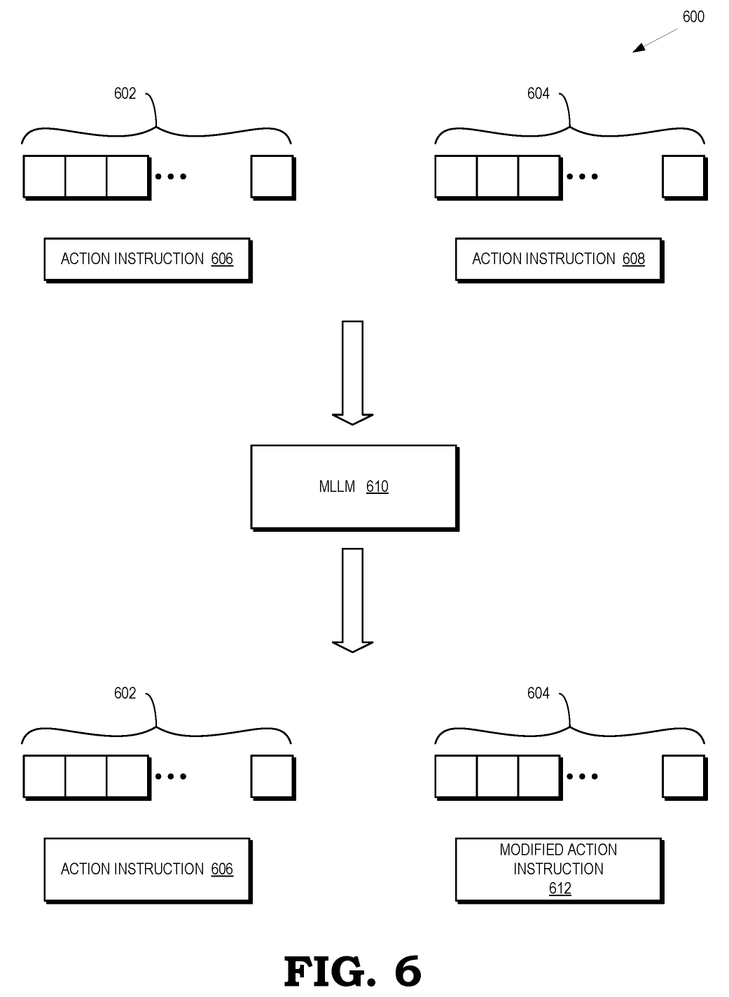

FIG. 6 illustrates a process or method 600 of generating modified action instructions for video segments that have higher semantic consistency with a text caption of a video, according to some embodiments. In the illustrated embodiment, the video has been partitioned into a set of video segments that includes the video segments 602, 604. Action instructions 606, 608 have been generated for the respective video segments 602, 604. The action instruction 606 has low semantic consistency with a text caption of the video and is therefore retained in a subset of video segments that are used for training purposes. The action instruction 608 has high semantic consistency with the text caption of the video and can therefore be discarded or removed from the subset of video segments. Instead of discarding the video segment 604 associated with the action instruction 608, the action instruction 608 can be modified to reduce its semantic consistency with the text caption.

In the illustrated embodiment, a multimodal large language model (MLLM) 610 is used to generate a modified action instruction 612 for the video segment 604. For example, the MLLM 610 can be trained to generate a modified action instruction based on an initial action instruction, a text caption of a video that includes a video segment, and the video segment. The training criteria can include modifying initial action instructions in training images or videos to reduce their semantic consistency with one or more text captions included in the training data. The video segment 604 can therefore be considered for inclusion in the training subset based on the modified action instruction 612. For example, if the modified action instruction 612 has a semantic consistency below a threshold value, the video segment 604 can be included in the training subset. Some embodiments of the MLLM 610 are used to generate other text descriptions, captions, or action instructions. For example, the MLLM 610 can generate text captions for an initial frame of the video (such as the initial frame 402 shown in FIG. 4) and an end frame of the video (such as the end frame 404 shown in FIG. 4). The MLLM 610 can also be used to generate a text description of a state transition between the initial frame and the end frame. The text captions, descriptions, or action instructions and then be stored in a memory such as the memory 107 shown in FIG. 1.

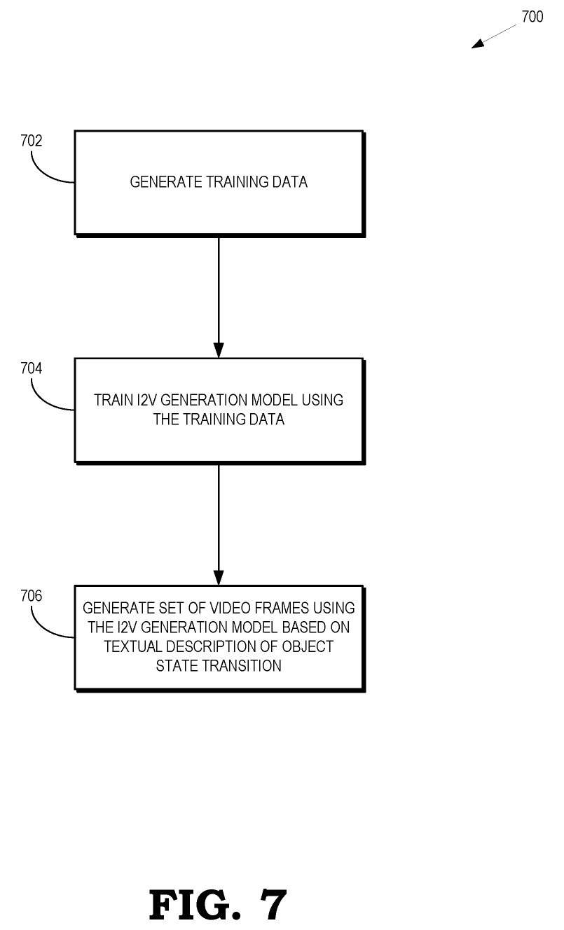

FIG. 7 illustrates a method 700 of training an I2V generation model to perform instructed visual state transition (IVST) and then performing IVST using the trained I2V generation model, according to some embodiments. The method 700 is implemented in some embodiments of the processing system 100 shown in FIG. 1.

At block 702, training data for the I2V generation model is generated. In some embodiments, the training data is generated and curated according to techniques discussed herein with regard to FIGS. 1-6. For example, action instructions can be generated for video fragments in a selected subset of video segments based on the object state transitions depicted in the video segments in the subset.

At block 704, the I2V generation model is trained based on the training data generated in the block 702. In some embodiments, the I2V generation model is trained based on stored information representing the selected subset of the video segments and the corresponding action instructions generated in block 702. For example, the I2V generation model can be trained to perform IVST.

At block 706, the trained I2V generation model is used to create one or more video frames that represent a plausible transition of an object’s state between images in an initial frame and an end frame, guided by a textual description. The initial frame depicts the object in its starting state, while the end frame represents the target state.

Datasets that are curated according to embodiments of the techniques discussed herein have several advantages over conventional video data sets. Some embodiments of the techniques discussed herein create video segments depicting individual object state transitions instead of the source video that can include several object state transitions. This supports task-specific optimization and helps align the dataset with the objective of modeling object state transitions based on action instructions, which enhances the relevance and the utility of the data for the task. Video segments with large amounts of motion or significant scene changes are removed and video segments with low visual quality can be filtered out, thereby improving the quality of the data that is used to train the models. This simplifies the learning process for the models and reduces complexity to allow generative models to concentrate on learning meaningful state transitions, which can improve efficiency and performance. Video segments that have low semantic consistency with annotated text prompts can also be excluded to improve the ability of the model to learn associations of text captions or action instructions and the object state transitions depicted in the corresponding video segments. Incorporating metrics such as brightness, blurriness, noise levels, and the like limits the retained data to visually high-quality data, which minimizes noise in the training process and can lead to better model generalization and output quality. The additional quality control for the validation set, such as filtering based on illumination or blurry levels, prevents poor quality samples from misleading model evaluation, which improves accuracy and benchmarking of model performance. Including various and diverse object state transitions, e.g., across indoor and outdoor scenarios, can generate a more diverse dataset that is adaptable to a wide range of applications and robust to different contexts.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A computer-implemented method comprising:
partitioning a video into video segments corresponding to object state transitions depicted in the video;
generating action instructions for each video fragment in a selected subset of the video segments based on the object state transitions depicted in the video segments in the subset;
storing the selected subset of the video segments and the corresponding action instructions in memory; and
training, based on stored information representing the selected subset of the video segments and the corresponding action instructions, an image-to-video (I2V) generation model to perform instructed visual state transition (IVST).

2. The method of claim 1, further comprising:
selecting the subset of the video segments based on visual quality scores for the video segments.

3. The method of claim 2, wherein selecting the subset of the video segments comprises:
generating a measure of similarity between initial and final frames of a respective one of the video segments ; and
storing the respective video segment as part of the selected subset when the measure of similarity is above a threshold.

4. The method of claim 2, wherein selecting the subset of the video segments comprises:
generating a measure of average optical flow between initial and final frames of a respective one of the video segments; and
storing the respective video segment as part of the selected subset when the measure of average optical flow is above a threshold.

5. The method of claim 1, further comprising:
generating a visual quality score for a respective one of the video segments based on at least one of a light level of the video segment, a brightness of the video segment, a blurriness of the video segment, or a noise level within the video segment; and
storing the respective video segment as part of the selected subset when the visual quality score is above a threshold.

6. The method of claim 5, wherein generating the visual quality score comprises assigning a low visual quality score to one of the video segments that has at least one of a low light level, a low brightness, a high level of blurriness, or a high level of noise.

7. The method of claim 5, wherein generating the visual quality score comprises generating the visual quality score by comparing a visual characteristic of one of the video segments to a corresponding threshold.

8. The method of claim 1, wherein generating the action instructions comprises generating text describing the object state transitions depicted in the video segments in the subset.

9. The method of claim 1, wherein generating the action instructions comprises evaluating the action instructions for semantic consistency with a text caption of the video, and wherein selecting the subset of the video segments comprises discarding video segments associated with action instructions having high semantic consistency with the text caption of the video.

10. The method of claim 9, further comprising:
generating, using a multimodal large language model (MLLM), at least one modified action instruction for at least one of the video segments, and wherein the at least one of the video segments is stored as part of the selected subset based on the at least one modified action instruction.

11. The method of claim 1, further comprising:
generating, using a multimodal large language model (MLLM), text captions for an initial frame of the video and an end frame of the video;
generating, using the MLLM, a text description of a state transition between the initial frame and the end frame; and
storing the text captions for the initial frame and the end frame and the text description of the state transition in the memory.

12. A computer-implemented method comprising:
accessing, from a memory, a subset of video segments based on visual quality scores for the video segments, wherein the video segments represent partitions of a video corresponding to object state transitions depicted in the video;
accessing, from the memory, action instructions associated with the subset of the video segments and a text caption of the video, wherein the action instructions indicate the object state transitions depicted in the video segments in the subset; and
training, based on the action instructions associated with the subset and the text caption, an image-to-video (I2V) generation model to perform instructed visual state transition (IVST).

13. The method of claim 12, further comprising:
accessing at least one modified action instruction for at least one of the video segments, wherein the at least one modified action instruction is generated using a multimodal large language model (MLLM).

14. The method of claim 13, further comprising:
accessing text captions for an initial frame of the video and an end frame of the video, wherein the text captions are generated by the MLLM; and
accessing a text description of a state transition between the initial frame and the end frame, wherein the text description is generated by the MLLM.

15. The method of claim 14, wherein training the I2V generation model comprises training the I2V generation model based on at least one of the subset of the video segments, the action instructions, the text caption of the initial frame, the text caption of the end frame, or the text description of the state transition between the initial frame and the end frame.

16. A non-transitory computer readable medium embodying a set of executable instructions, the set of executable instructions to manipulate at least one processor to:
partition a video into video segments corresponding to object state transitions depicted in the video;
generate action instructions for each video fragment in a selected subset of the video segments based on the object state transitions depicted in the video segments in the subset;
store the selected subset of the video segments and the corresponding action instructions in memory; and
train, based on stored information representing the selected subset of the video segments and the corresponding action instructions, an image-to-video (I2V) generation model to perform instructed visual state transition (IVST).

17. The non-transitory computer readable medium of claim 16, wherein the set of executable instructions is to manipulate the at least one processor to determine a measure of similarity between initial and final frames of the video segments in the subset, determine average optical flows within the video segments in the subset, and discard video segments having at least one of a low measure of similarity or a low average optical flow.

18. The non-transitory computer readable medium of claim 16, wherein the set of executable instructions is to manipulate the at least one processor to generate a visual quality score for one of the video segments based on at least one of a light level of the video segment, a brightness of the video segment, a blurriness of the video segment, or a noise level within the video segment.

19. The non-transitory computer readable medium of claim 16, wherein the set of executable instructions is to manipulate the at least one processor to evaluate the action instructions for semantic consistency with the text caption of the video and discard video segments associated with action instructions having high semantic consistency with the text caption of the video.

20. The non-transitory computer readable medium of claim 16, wherein the set of executable instructions is to manipulate the at least one processor to generate, using a multimodal large language model (MLLM), at least one modified action instruction for at least one of the video segments and determine whether to include the at least one of the video segments based on the at least one modified action instruction.
